(19) United States
(12) Patent Application Publication
(10) Pub. No.: US 2023/0108638 A1
(43) Pub. Date: Apr. 6, 2023

(54) MAGNETIC LIGHT CORD FOR USE WITH A BEVERAGE MAKING AND DISPENSING MACHINE

(71) Applicant: BUNN-O-MATIC CORPORATION, Springfield, IL (US)

(72) Inventors: Jeffery W. KADYK, Springfield, IL (US); Mark BANDIXEN, Springfield, IL (US)

(21) Appl. No.: 17/959,804

(22) Filed: Oct. 4, 2022

Related U.S. Application Data
(60) Provisional application No. 63/252,081, filed on Oct. 4, 2021.

(51) Int. Cl. A47J 31/44; H01R 13/62

(52) U.S. Cl. CPC A47J 31/4403; H01R 13/6205

(57) ABSTRACT

Disclosed is a hardline connection assembly for connecting a portion, such as a lid, of a beverage making apparatus to a lower portion of the apparatus to provide an electrical connection. The hardline connection assembly includes a line with a magnetic connector assembly attached to one end of the line. The magnetic connector assembly including a first end and a second end to provide a magnetically attractive connection capable of bringing together the first and second ends and of making an electrical connection between the ends. The magnetic assembly also allows for breakaway disengagement of the ends without damage to the line connection to the lid and connection of the connector attached to the apparatus. A kit of the hardline connection assembly is provided for retrofitting existing apparatus.

### CROSS REFERENCE TO RELATED APPLICATIONS

This application claims the benefit of priority under 35 U.S.C. § 119(e) to U.S. Provisional Patent Application No. 63/252,081, filed Oct. 4, 2021. The disclosure set forth in the referenced application is incorporated herein by reference in its entirety.

### FIELD OF THE INVENTION

The field of the invention involves hardline connectors for providing electrical connections between two portions of a beverage dispensing machine. This arrangement operates in a food service environment involving moisture, liquids, sugars, flavorings, possibly alcohol, and other food related ingredients.

### BACKGROUND

The present disclosure relates to an improvement in the beverage making and dispensing machine, beverage making apparatus, or apparatus for producing a chilled or partially frozen beverage often referred to as a slush beverage. A variety of apparatus have been designed to produce chilled beverages as well as to produce beverages that are in slush form. Some of these apparatus are referred to as “granita” machines. Such apparatus can be used to produce slush beverages for a number of products including, but not limited to, fruit juice-based beverages, coffee-based beverages, tea-based beverages, dairy-based beverages, as well as beverages containing alcohol. The apparatus includes at least one beverage hopper, a chilling structure and some form of blade or auger assembly operatively positioned and retained in the hopper, and a beverage mixture used in the process. The auger assembly controllably moves relative to the chilling portion to shave the frozen or partially frozen beverage mixture away from and circulate the beverage along the chilling portion. Circulation of the semi-frozen beverage mixture within the beverage hopper and along the chilling portion helps to reduce the temperature of the beverage mixture thereby causing the partially frozen beverage to approach a slush consistency neither fully frozen nor fully liquid.

These type of beverage apparatus include a lid attached to the upper portion of each beverage hopper. The lid encloses the beverage hopper to prevent the intrusion of unwanted materials that might be found in the ambient environment in which the apparatus operates. Additionally, these lids have been developed to include illuminated areas that can provide for illuminated advertising or other information on the lid. Furthermore, these lid constructions can also include illumination generally downwardly into the hopper below the lid to illuminate the product contained in the hopper. One of the requirements is to provide power to the lid to provide its illuminating activities. In doing so, the lid can be provided with a wireless power source such as a battery or other means for delivering power to the lid without a direct physical connection. However, lids are usually wired to the apparatus to convey power from the lower portion of the machine including the hoppers to the lids retained on top of the hoppers. This wired connection could be used for other purposes as well.

From time to time, the lid must be removed from the hopper in order to manage the beverage mixture in the hopper, clean the hopper, or other activities associated with removing a lid from the hopper. As a result, the operator must be careful to disconnect the lid from the hopper in order to prevent damage to the connections either at the machine or at the lid. Prior art connections include an RCA-type press fit connector, and/or connectors that have a threaded engagement to retain one end of the connector wired to the lid to another end of the connector attached to the apparatus. However, when the connector is not properly or fully disconnected before removing the lid from the hopper, the connection can be damaged as a result of the lid falling away from the apparatus or the operator not knowing of nor appreciating the connection of the hardline between the lid and machine.

As a result, the connector between the lid and the apparatus and the connection between the wire or line and the lid can be damaged requiring repair or replacement. Such damage can result in down time of the illumination of the lid which might make the product in the hoppers less appealing to potential customers as well as possibly reducing the advertising displayed by the illumination. There will also be down time and lost beverage sales associated with the repair of the apparatus if the connection to the machine is damaged since the apparatus and will be powered down for safety when making the repair. Powering down of the machine will cause the beverage mixture to melt or increase in temperature requiring additional time for the mixture to refreeze to a desired serving temperature and consistency.

It would be desirable to develop structures and/or methods for connecting the lid to the apparatus that eliminates the damage that occurs between these devices. Moreover, this type of beverage producing environment involves high degrees of moisture, food ingredients including sugars and flavorings, and other characteristics that are detrimental to an electrical connection.

This background information is provided merely for context. No admission is intended, nor should such admission be inferred or construed, that any of the preceding information constitutes prior art against the present disclosure. Other aims, objects, advantages and features of the invention will become more apparent upon reading of the following non-restrictive description of specific embodiments thereof, given by way of example only with reference to the accompanying drawings.

### BRIEF DESCRIPTION OF THE DRAWINGS

The present disclosure is described hereafter with reference to the attached drawings that are given as a non-limiting example only. Embodiments of the present disclosure are provided with reference to the appended drawings, wherein:

FIG. 1 is a perspective front view of a beverage-making apparatus of the type which can use a hardline assembly of the claimed invention, this embodiment of the beverage apparatus does not include the hardline assembly but can be configured to have the hard wire assembly installed;

FIG. 2 is a perspective view of a beverage-making apparatus which includes a hardline assembly installed to connect a first portion of the apparatus with a second portion of the apparatus, the first portion of the apparatus being a lower portion from which power can be supplied and connecting to a lid positioned on top of a hopper of the apparatus, whereby the connection provides a flow of power from the lower portion of the apparatus to the lid for such purposes as providing illumination in the lid;

FIG. 3 is an enlarged rear perspective view of a portion of the beverage apparatus showing the hardline assembly connecting the lower portion of the apparatus to the lid;

FIG. 4 is partial cross sectional, elevational view of a magnetic connector assembly of the hard wire assembly aligned for engagement, including a first portion for attachment to the lower portion of the apparatus with second portion attached to a line connected to the lid, whereby magnetically attractive engagement of the first portion and second portion provides for an electrical circuit to at least convey power from the lower portion to the lid, a side view of the first portion also being shown in FIG. 4;

FIG. 5 is a partial fragmentary view of a connector harness for connection to an internal electrical component of the apparatus for delivering power to the first portion of the magnetic connector assembly;

FIG. 6 shows an illumination assembly such as using LEDs and/or LED boards connected to the line of the hardline connection assembly providing a portion of a kit for retrofitting or otherwise installing a hardline connection with a magnetic connection between the lid and the lower portion of the apparatus, the kit including at least the hardline or wires, the second magnetic connector portion attached to the line, and a first magnetic connector portion for attachment to the lower portion of the apparatus, the kit replacing existing components having a threaded or otherwise fixed connection to reduce possible problems associated with damage to the connector assembly;

FIGS. 7 and 8 show a preferred embodiment of the magnetic connector assembly shown in a partially fragmentary, partial cross-sectional view, FIGS. 7 and 8 show the first portion attached to the cover portion for receiving the second portion in a connecting relationship therewith, the first portion having a convex protrusion with the second portion having a concave portion for engaging the convex protrusion;

The exemplification set out herein illustrates embodiments of the disclosure that are not to be construed as limiting the scope of the disclosure in any manner. Additional features of the present disclosure will become apparent to those skilled in the art upon consideration of the following detailed description of illustrative embodiments exemplifying modes of carrying out the disclosure as presently perceived.

### SUMMARY OF INVENTION

According to the embodiments of the present disclosure, a beverage producing apparatus, a hardline connection assembly for use with the beverage producing apparatus to connect to portions, components, or other elements of the apparatus, a method for connecting portions, components, or other elements of the apparatus, as well as a kit for use with a beverage apparatus.

In illustrative embodiments, the hardline connection assembly connects a lid of a beverage apparatus to a lower portion of the apparatus to provide an electrical connection between the lower portion and the lid. The hardline connection assembly includes a line with a magnetic connector assembly attached to one end of the line. The magnetic connector assembly including a first end and a second end to provide a magnetically attractive connection capable bringing together the first and second ends and of also making an electrical connection between ends. The magnetic connection allows for at least the transfer of energy from the lower portion of the apparatus to the lid. The magnetic connection includes a first portion attached to the apparatus and sealed against the intrusion of substances between the first connection and the apparatus. The second portion of the magnetic connector assembly includes a skirt at least prevents shorting of the connections while being engaged and/or disengaged. The skirt also can provide a substance resistant interface between the connector portions. A kit of the hardline assembly includes a line with a lid end for connection to the lid of the beverage apparatus. A connector end of the line includes the second portion of the magnetic connector assembly attached thereto. The kit also includes the first portion of the magnetic connector assembly for attachment to the beverage apparatus.

In at least one embodiment, an apparatus for facilitating an electrical connection is disclosed, the apparatus comprising a first portion and a second portion. The first portion comprises a convex portion, a magnetic surface, and a protrusion. The second portion comprises a concave structure, a skirt, a second surface, and a second protrusion. The first protrusion and the second protrusion are electrically conductive, and when the first protrusion contacts the second protrusion, the magnetic surface does not contact the second surface.

According to another embodiment, an apparatus for facilitating an electrical connection comprises a first portion and a second portion. The first portion comprising a convex protrusion and a magnetic surface. The second portion comprises a concave portion, a second surface, and a conductive portion. The first convex protrusion and the conductive portion are electrically conductive, and when the convex protrusion is received by the concave portion.

In an embodiment of a beverage making apparatus, the apparatus comprises a base, a lid, and an electrical connection joining the base to the lid. According to such an embodiment, the electrical connection comprises a first portion and second portion. The first portion comprises a convex portion, a magnetic surface, and a protrusion. The second portion comprises a concave structure, a skirt, a second surface, and a second protrusion. The first protrusion and the second protrusion are electrically conductive, and when the first protrusion contacts the second protrusion, the magnetic surface does not contact the second surface.

Other aims, objects, advantages, aspects and features of the disclosure will become more apparent upon reading of the following non-restrictive description of specific embodiments, given by way of example only with reference to the accompanying drawings.

### DETAILED DESCRIPTION

While the present disclosure may be susceptible to embodiment in different forms, there are shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

The terms used herein should be broadly interpreted throughout this application to include all known as well as all hereafter discovered versions, equivalents, variations and other forms of the abovementioned terms as well as other terms. The present disclosure is intended to be broadly interpreted and not limited. The embodiment(s) detailed herein, and features thereof, may be combined in full or in part with one another or in alternative to one another

The use of various phrases and terms is meant to encompass the items or functions identified and equivalents thereof as well as additional items or functions. Unless limited otherwise, various phrases, terms, and variations thereof herein are used broadly and encompass all variations of such phrases and terms. However, other alternative structures, functions, and configurations are possible which are considered to be within the teachings of the present disclosure. Furthermore, unless otherwise indicated, the term “or” is to be considered inclusive. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical, mechanical or other connections or couplings. The terms upper, lower, and vertical are intended for operative context only and are not necessarily intended to limit the invention only to those configurations or orientations.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

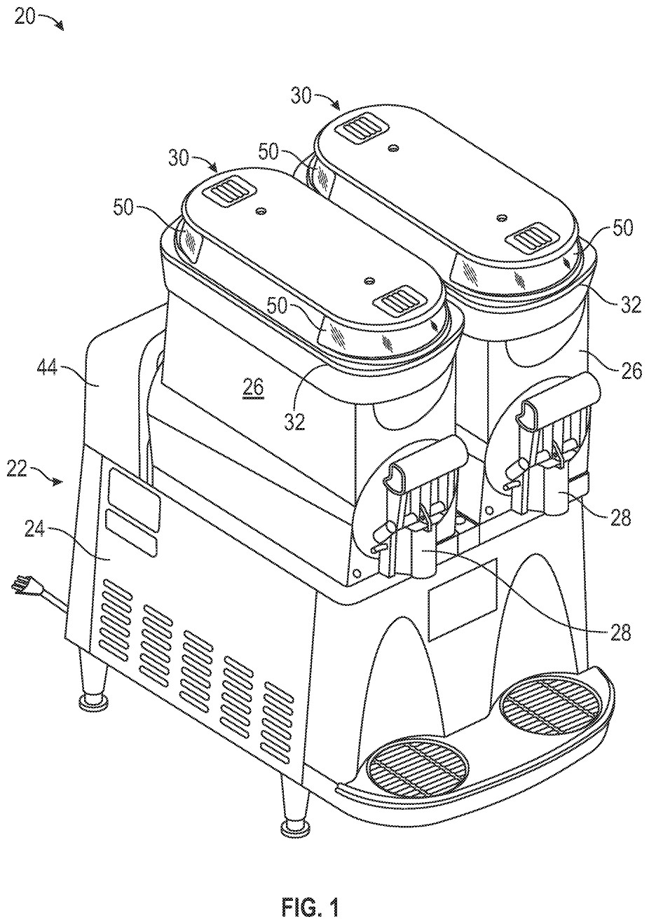

As shown in FIG. 1, a beverage making apparatus 20 is shown which is a characteristic design for use in transforming a beverage mixture into a slush, semi-frozen, or “granita”-style beverage. The apparatus 20 includes a lower portion or base 22 having a housing 24 containing a cooling system and associated electronics for controllably reducing the temperature of the beverage mixture retained for dispensing from the machine. As shown in FIG. 1, a pair of hoppers 26 are positioned on top of the base 20 for retaining the beverage made therein. A valve assembly 28 is associated with each hopper for controllably dispensing beverage from the corresponding hopper 26. A lid 30 is positioned to cover an open mouth 32 of each hopper 26 to prevent items or particles in the ambient environment from entering the hopper 26 and mixing with the beverage retained in the hopper 26.

An example of such a beverage apparatus is described and illustrated in U.S. Pat. No. 6,058,721, which issued on May 9, 2000; U.S. Pat. No. 6,430,952, which issued on Aug. 13, 2002; U.S. Pat. No. 6,619,056, which issued on Sep. 16, 2003; and U.S. Pat. No. 7,152,765, which issued on Dec. 26, 2006, and the full content of each of these patents is incorporated by reference in its entirety herein.

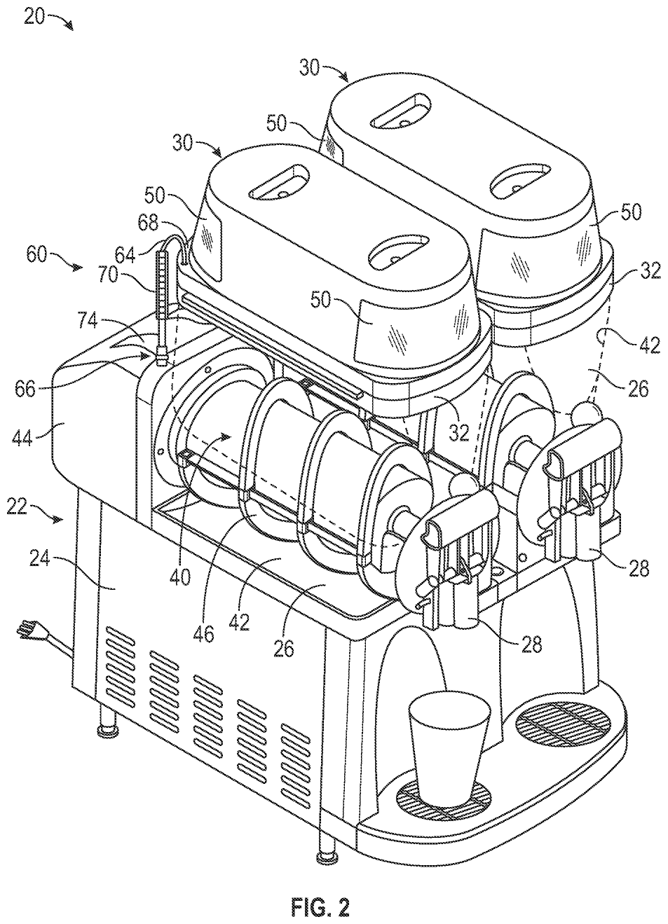

As shown in FIG. 2, the hoppers 26 are shown as being transparent (see broken lines). FIG. 1 is provided to show the overall elements of the apparatus 20 with FIG. 2 showing additional details.

As shown in FIG. 2, a cooling assembly in the shape of a cylinder or drum 40 extends into a cavity 42 defined by each hopper 26. The cooling assembly 40 is connected to the base 22 through a mechanical assembly within a cover area 44 associated with each hopper 26. The cover area 44 includes linkages which extend through the drum 40 to rotate an auger assembly 46 associated with each cooling assembly 40. In addition, inside each cooling assembly 40, a series of cooling coils are provided to reduce the external surface temperature of the cylindrical drum. The combination of the temperature reduction by the cooling assembly cylinder 40 and the movement of an auger assembly 46 results in chilling and semi-freezing of beverage mixture retained within the cavity 42 of each hopper 26. Continued cooling and rotation of the auger 46 results in scraping off layers of the reduced temperature beverage material from the outside surface of the drum 40 to form the granita beverage.

The granita beverage includes ingredients such as water, sugar, flavorings, color, and may, in some recipes, include alcohol or dairy based ingredients. Once the beverage is chilled within the hopper 26 it becomes thicker and cooler and provides a pleasant beverage experience including flavors, aromas, temperature, and mouth-feel.

During the operation of the apparatus 20 additional ingredients may need to be added, or, periodically the hopper 26 may need to be cleaned. As one would appreciate, food quality ingredients need to be maintained on a hygienic schedule to make sure that the beverage experience is maximized. As such, the lid 30 will need to be removed from time to time. The lids 30 include an illumination assembly such as LED light boards which can be placed within the lid 30 for illuminating display panels 50 such as found at the front and rear of the lids 30 shown in the figures. In addition, a lower portion of the lid extending over the mouth 32 of the hopper 26 can be illuminated to provide illumination to the beverage substance retained within the hopper 26. This can enhance the beverage experience, draw attention to the beverage, and whet the appetite of the consumer for the beverage.

In order to illuminate the LEDs a power source must be provided. While a wireless power source could be used there can be issues associated with such power sources. A preferred power source is to provide a hardline or wired connection to deliver power from the base 22 of the apparatus 20.

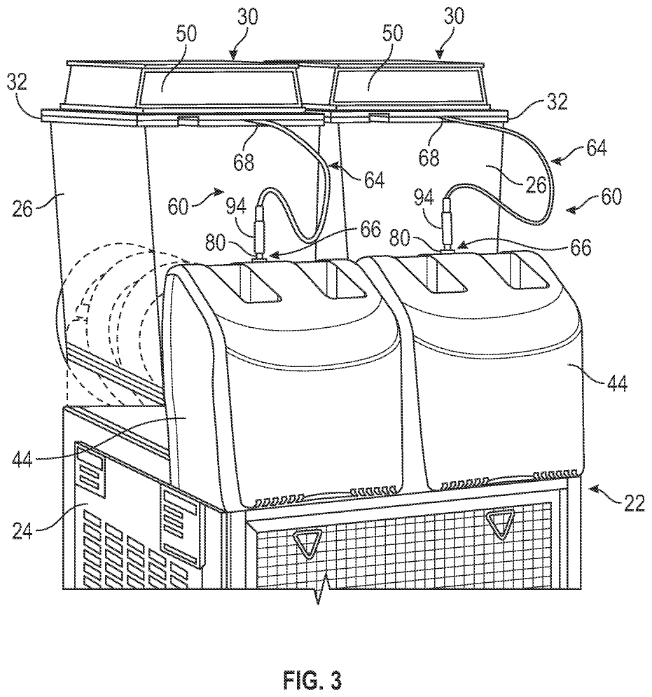

As shown in FIGS. 2-6 a hardline assembly 60 and elements thereof are shown. The hardline assembly 60 provides a physical connection between the base 22 and the lid 30. The hardline assembly 60 provides the electrical connection between these components. While an electrical connection is identified in the illustrated embodiment, it should be appreciated that an optical connection could also be provided within the scope of this disclosure. In this regard, an optical source could be provided in the base 22 with an optical fiber assembly connecting the base to the lid providing illumination to the lid through an optical array in generally the same manner as shown for the electrical wire connection. While this optical configuration and other configurations may be developed they will necessarily use the invention of this disclosure to achieve the benefits of this disclosure.

In addition, while a one-way electrical connection is shown and described, it should be appreciated that a two-way connection can be made using the teachings of the present disclosure. In this regards a two-way connection between the lid 30 and base 22 could be used to connect an information receiving or transfer device. Such a device could be a microphone, speaker, camera, payment method device, ambient environment sensors, or other devices connected to the apparatus which are currently known or hereafter implemented for use with the apparatus.

In this regard, one of the problems that occurs with removing the lid 30 from the hopper 26 is that an operator might temporarily place the lid out of the way. While the hardline assembly 60 includes a line 64, a coupler assembly 66 and a lid end 68 attached to the lid 30, it is generally designed to be relatively short and not provide much range of motion when removing the lid 30. A coiled portion 70 can be provided in the line 64 to provide additional flexible range of motion for the lid 30 relative to the hopper 26 however; there is at least some limit to the range of motion between these components.

When an operator removes the lid 30 from the hopper 26 they need to place it somewhere or otherwise completely remove it from the apparatus 20. If the operator places it near the apparatus it can fall and result in stretching the line 64, which is a tethered connection between the lid 30 and a contact point at the coupler assembly 66. If the coupler assembly 66 is not properly configured it can result in damage to the coupler assembly. The present invention provides a coupler assembly 66 that is a magnetically attractive and retaining connection with additional features. The magnetic connection of coupler assembly 66 allows for a fast-release, damage-free release or other “breakaway” connection that prevents damage to the apparatus 20 and any of the connective components of the hardline assembly 60 as well as the lid 30. In this regard, the benefits of the coupler's magnetic coupler assembly 66 prevents damage to the lid end 68 of the line 64 as well as the cover end 74. This invention also allows for the disconnection of the coupler assembly 66 to prevent damage to the portion 68 of the line 64 that attaches to the cover 44. As a result, the benefits of this invention help assure that the electrical connection between the lower portion or base 22 and the lids 30 does not become damaged and reduce the operating aspects of the apparatus 20.

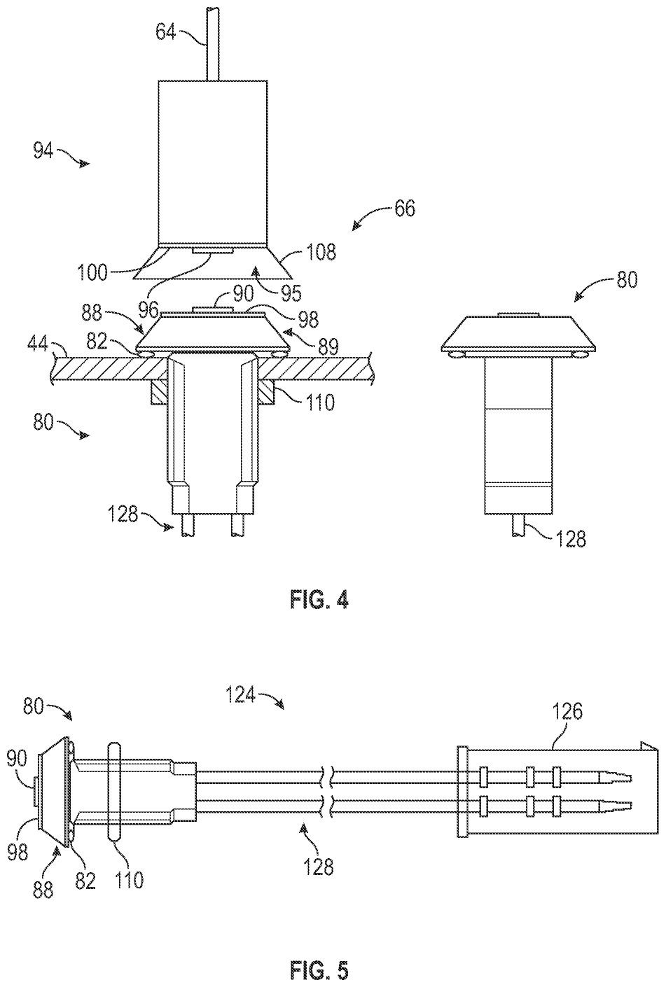

As shown in greater detail in FIG. 4, the magnetic coupler assembly 66 includes a first portion 80 attached to the cover 44 of the apparatus 20. The portion of the cover 44 as shown in cross section providing an opening 82 through which an upper portion 88 extends above the cover surface 44. The upper portion 88 is formed with a generally convex surface 89 protruding above the surface of the cover 44 to provide a connection point. A first protrusion 90 extends from the convex portion 89 to provide an electrical connection. The convex portion 89 is shown as a partial conical structure in FIG. 4. Other convex structure geometries can be used with this design to achieve the results.

A second portion 94 is provided attached to the line 64 for magnetic attraction and connection to the first portion 80. The second portion 94 includes a second protrusion 96 which is configured for alignment with the first protrusion 90. The corresponding first surface 98 and second surface 100 of the first 80 and second 94 portions have a magnetic configuration to attract, engage, and retain the first and second portions (80, 94). When the first and second surfaces 98, 100 are engaged the first and second protruding portions 90, 96 engage providing an electrical connection and completing the electrical circuit to provide power from the base 22 to the lid 30. The electrical connection is used to at least power the illuminating components of the lid 30. The second portion 94 includes a concave structure 95 of a complimentary configuration to cooperatively engage the convex portion 89 of the first portion 80. In this regard, any of appropriately complimentary concave and convex structures (95, 89) may be used to achieve the coupling benefits.

The first portion is attached to the cover 44 with a threaded nut 110 to retain the first portion 80 on the apparatus. Any number of other connector and attachment configurations are included within this disclosure as might be necessary or practical for purposes of attaching these components. As shown in FIG. 4, a sealing O-ring can also be provided between the elements of the first portion to provide an additional seal of the cover portion 44. As mentioned herein, the operating environment of these components involves moisture, liquids, food ingredients such as sugars, water, flavorings, color, and in some situations alcohol and/or dairy products. As such, it is desirable to prevent the intrusion of these substances through the cover 44.

As an additional matter, it is important to note that the concave structure 95 which is cooperatively formed to engage the convex structure 88, 89 could be reversed between the portions 80, 94. However, in a preferred embodiment the convex portion 89 is positioned on the first portion 80 so as to shed any substances that might fall on the structure. This also allows for relatively quick and easy removal by an operator during routine maintenance. The concave portion can also be characterized as a skirt or shield 108. Both the convex portion 89 and concave portion 95 including and defining the shape of the skirt 108 can be formed of an insulating material. The skirt 108 is beneficial such that it helps to align the connection and provide proper alignment and engagement of the protrusions 90, 96 when magnetically attracted to each other. Also, importantly, the skirt 108 also prevents shorting the components by accidentally contacting structures other than the protrusions 90, 96. In other words, if a conductive surface other than the protrusions 90, 96 contact one of the protrusions it can cause a short between these components. Proper alignment and engagement of the portions 80, 94 helps assure reliable and repeated connections without shorting any portions of the apparatus.

According to at least some embodiments, the angle between the magnetic surface 98 and the convex portion 89 matches the angle between the second surface 100 and the skirt 108. This allows the convex portion 89 to abut the inside of the skirt 108 and make contact, while the first protrusion 90 and second protrusion 96 contact, yet maintaining a space between the magnetic surface 98 and the second surface 100.

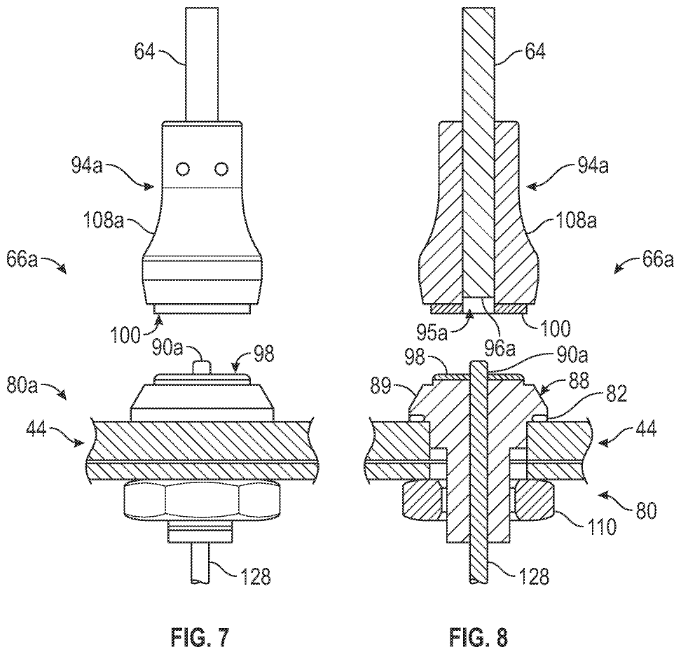

As shown in FIGS. 7 and 8, a preferred embodiment of the connector assembly 66 is shown with the same elements referred to by the same numbers as used previously in this disclosure and new elements identified by new reference numbers and elements that are similar to prior reference numbers identified with an alphabetic suffix, for example “connector assembly 66a”.

FIG. 7 shows in a side elevational view, the cover portion 44 shown in cross- section with the remainder of the components of the connector assembly 66a shown in a solid line. To help additionally describe this configuration, a more complete cross section is shown in FIG. 8.

As shown in FIGS. 7 and 8, the first portion 80a is attached to the cover portion 44. A magnetic surface 98 surrounds a convex protrusion 90a. The second portion 94a includes a non-conductive skirt portion 108a and includes a concave portion 95a. Instead of the concave portion 95a engaging the convex surface 89 of the first portion 80a, the concave portion 95a is surrounded by the non-conductive insulating skirt 108a for engaging only the convex protruding portion 90a. Nevertheless, the relationship of the insulating portion 108a protects and prevents shorting when engaging or otherwise in relation to the first portion 80a. Within the concave portion 95a is the contact 96a for conductively engaging the corresponding portion of the protrusion 90a.

This preferred embodiment as shown in FIGS. 7 and 8 can be fully incorporated into the kit as described herein. In addition, the overall structure and function is similar or identical to that as shown in the other figures in this disclosure. In this regard, the function of the magnetically attractable and engageable connector assembly 66a functions to attract the two portions 80a, 94a to engage the conductive portions 90a, 96a while providing a breakaway connector that helps protect the lid 30 and the base 22 and related structures of the apparatus 20. While the protrusion 90a extends a dimension above the surrounding magnetic portion 98 and a corresponding concave portion 95a as provided on the second portion 94a, a force such as tension applied to the line 64 can overcome the magnetic attractive forces between the portions 80a, 94a. The magnetic components 98a, 100a are sized and dimensioned to provide sufficient force to provide a generally secure connection between the components while still allowing for a breakaway connection between the two components. The breakaway connection helps preserve and protect at least the lid 30 and the base 22 of the apparatus 20. The breakaway-type connection also prevents damage to the connector portions 80a, 94a, preventing or reducing the need to repair or replace these components.

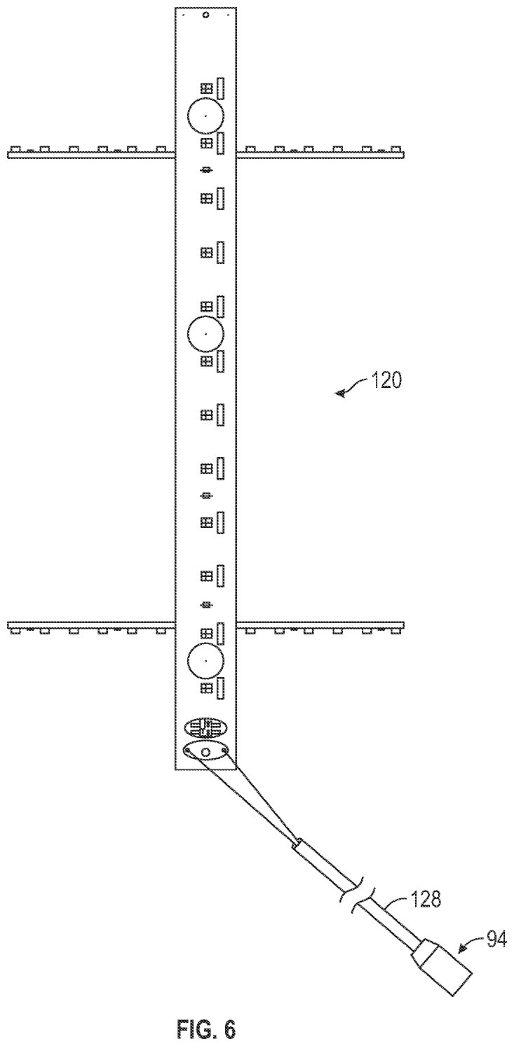

As another feature of this disclosure, the hardline assembly can be provided as a kit of components for attachment to or retrofitting of a beverage making apparatus. In this regard, the kit can include the hardline assembly 60 including the line or cord 64, the magnetic connector assembly 66, with the second portion 94 already attached to the line 64 and the first portion 80 including appropriate connectors such as the nut 110 and the seal or O-ring 82. The kit can be provided with free ends at the second end 68 of the line for attachment to an existing illumination assembly in the lid 30 or can be provided with push-together-type connectors compatible with such a connector already attached to the lid 30. Alternatively, an LED assembly 120 (see FIG. 6) can be included connected to the second end 68 of the line. In this alternative kit including the LED assembly 120, the LED assembly can be installed in the cavity of the lid if an illumination assembly is not previously provided or to replace an existing illumination assembly. The LED assembly 120 will be sized and configured for use with appropriate lid assemblies as per manufacturer specifications or otherwise.

Another alternative embodiment of the kit can also include a harness 124 (see FIG. 5) which includes a Tyco connector 126 at one end of the corresponding wires 128 of the harness 124 and the first portion 80 of the connector assembly 66 already attached to the wires 28 of the harness 124.

According to some embodiments of a kit, the harness 124 and corresponding wires 128 terminate in a protruding connector (not shown). In other embodiments, the corresponding wires 128 terminate in a protrusion receiving connector (not shown). According to other embodiments, the corresponding wires 128 terminate with clamps, inductive connectors, or other connector types designed to splice into existing electrical wires.

In this regard, several different kit configurations and/or combinations thereof can be provided for use in different situations.

In use, the hardline assembly 60 provides the electrical connection between the lid 30 of the beverage making apparatus 20 positioned on the hopper 26 of the apparatus 20 and an electrical source such as can be found in the base 22 of the apparatus 20. The hardline assembly 60 includes the connector assembly 66, which provides magnetic coupling between a first portion 80 and a second portion 94. A skirt 108 formed of an insulating material is provided in a cooperative configuration to mate with a upper portion 88 of the first portion 80. The insulating properties of the skirt 108 prevent shorting of the system by misalignment or accidental contact.

When the components 80, 94 of the connector assembly 66 are aligned and magnetically attracted the corresponding first and second protrusions 90, 96 of the connector assembly 66 are brought together and provide a suitable electrical connection held together under magnetic forces associated with the magnetic surfaces 98, 100. As should be noted, the magnetic surfaces 98, 100 are the result of a magnetic material being attached to or otherwise placed on these surfaces either through over molding on the magnetic material, embedding the magnetic material in the surface, applying through deposition or coating such magnetic material, or any other currently known or hereafter created method for attaching or applying such magnetic material. In use, a force applied to the connector assembly 66 can overcome the attractive magnetic forces resulting in disconnection without damage to the connector assembly 66.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation to encompass all such modifications and equivalent structures and functions.

1. An apparatus for facilitating an electrical connection, the apparatus comprising:
a first portion;
the first portion comprising a convex portion, a magnetic surface, and a protrusion;
a second portion;
the second portion comprising a concave structure, a second surface, and a second protrusion;
wherein the first protrusion and the second protrusion are electrically conductive, and when the first protrusion contacts the second protrusion, the magnetic surface does not contact the second surface.

2. The apparatus of claim 1, wherein the convex portion abuts a skirt when the first protrusion contacts the second protrusion.

3. The apparatus of claim 2, wherein the angle between the magnetic surface and the convex portion matches the angle between the second surface and the skirt.

4. The apparatus of claim 3, wherein electrical current flows from the first portion to the second portion.

5. The apparatus of claim 4, wherein the second portion is affixed to a line.

6. The apparatus of claim 5, wherein the line features a coiled portion.

7. The apparatus of claim 1, wherein the first portion comprises a threaded component.

8. The apparatus of claim 7, wherein the first portion further comprises a protruding electrical connector opposite the convex portion.

9. A kit for use with a beverage making apparatus for facilitating a hardwired electrical connection between two portions of the apparatus, the kit comprising:
a first portion;
the first portion including a convex protrusion and a magnetic surface;
a second portion;
the second portion including a concave portion, a second surface, and a conductive portion;
wherein the first convex protrusion and the conductive portion are electrically conductive, and when the convex protrusion is received by the concave portion.

10. The apparatus of claim 9, wherein the magnetic surface contacts the second surface when the convex protrusion is received by the concave portion.

11. The apparatus of claim 10, wherein electrical current flows from the first portion to the second portion.

12. The apparatus of claim 11, wherein the second portion is affixed to a line.

13. The apparatus of claim 12, wherein the line features a coiled portion.

14. A beverage making apparatus, the apparatus comprising:
a base;
a lid;
an electrical connection joining the base to the lid, the connection comprising:
a first portion;
the first portion comprising a convex portion, a magnetic surface, and a protrusion;
a second portion;
the second portion comprising a concave structure, a skirt, a second surface, and a second protrusion;
wherein the first protrusion and the second protrusion are electrically conductive, and when the first protrusion contacts the second protrusion, the magnetic surface does not contact the second surface.

15. The beverage making apparatus of claim 14, wherein the base includes a cooling assembly in the shape of a cylinder.

16. The beverage making apparatus of claim 15, wherein the cooling assembly is surrounded by an auger assembly.

17. The beverage making apparatus of claim 14, wherein the lid includes a lighting assembly.

18. The beverage making apparatus of claim 14, wherein the first portion is retained in the base by a threaded nut.

19. The beverage making apparatus of claim 14, wherein the first portion is electrically connected to a power source in the base.

20. The beverage making apparatus of claim 19, wherein the electrical connection between the first portion and the power source is facilitated by a protruding connector wired to the first portion.
